(19) United States
(12) Patent Application Publication
(10) Pub. No.: US 2026/0161442 A1
(43) Pub. Date: Jun. 11, 2026

(54) EFFICIENT EXECUTION OF DEPENDENT TASKS

(71) Applicant: NVIDIA Corporation, Santa Clara, CA (US)

(72) Inventors: Tu Hong, Shanghai (CN); Gentaro Hirota, San Jose, CA (US); Shayani Deb, Seattle, WA (US); Haldun Umur Darbaz, Santa Clara, CA (US); Andrew Gacek, San Jose, CA (US); Parth Bhogate, San Jose, CA (US); Nipun Agarwala, Santa Clara, CA (US); Prathyush Kama, San Jose, CA (US)

(21) Appl. No.: 18/973,334

(22) Filed: Dec. 9, 2024

(51) Int. Cl. G06F 9/48

(52) U.S. Cl. CPC G06F 9/4818

(57) ABSTRACT

Disclosed are circuits and techniques for efficient execution of dependent tasks. The techniques include retrieving from a memory a consumer task that depends on a producer task executed by a processing device and retrieving from the memory a first other task. The techniques further include, responsive to a first execution state of the producer task at a first time satisfying a first execution criterion, providing the first other task for execution by the processing device. The techniques further include, responsive to a second execution state of the producer task at a second time satisfying a second execution criterion, providing the consumer task for execution by the processing device.

### TECHNICAL FIELD

At least one embodiment pertains to scheduling task for execution by a processor, and more specifically, to scheduling tasks for execution that depend on one or more other tasks.

### BACKGROUND

Processors (e.g., central processing units (CPUs), graphics processing units (GPUs), data processing units (DPUs), parallel processing units, accelerator engines, etc.) of a processing device can execute tasks from multiple processes concurrently. Tasks can have an associated priority and can be executed based on their priority. Before execution, the tasks can be loaded from memory and stored in a scheduling table, which can have limited space (e.g., due to hardware constraints). An in-memory task descriptor can be used to manage the tasks (e.g., to be able to suspend a running task and resume the next task selected to run based on priority) while they are in the scheduling table. The in-memory task descriptor can contain task state associated with a task, such as its dependency tracking information, resource requirements, the number of threads (e.g., thread blocks) to execute, and a current state (e.g., rasterization state) of the task.

### BRIEF DESCRIPTION OF THE DRAWINGS

FIG. 1 is a block diagram of an example computer system for efficient execution of dependent tasks, according to at least one embodiment.

FIG. 2 is an example graph of processing unit occupancy over time, according to at least one embodiment.

FIG. 3 is a flow diagram of an example method of holding a consumer task's execution for efficient execution of dependent tasks, according to at least one embodiment.

FIG. 4 is a flow diagram of an example method of demoting a consumer task's priority for efficient execution of dependent tasks, according to at least one embodiment.

FIG. 5 is a flow diagram of an example method for efficient clean-up operations of producer tasks, according to at least one embodiment.

FIG. 6 is a block diagram illustrating an exemplary computer system, in accordance with at least one embodiment of the present disclosure.

FIG. 7A illustrates inference and/or training logic, according to at least one embodiment of the present disclosure.

FIG. 7B illustrates inference and/or training logic, according to at least one embodiment.

FIG. 8 illustrates training and deployment of a neural network, according to at least one embodiment.

FIG. 9 is an example data flow diagram for an advanced computing pipeline, according to at least one embodiment.

FIG. 10 is a system diagram for an example system for training, adapting, instantiating and deploying machine learning models in an advanced computing pipeline, according to at least one embodiment.

### DETAILED DESCRIPTION

A processor scheduler may receive (e.g., load) multiple tasks from memory into a scheduling table. The tasks may be dispatched from the scheduling table for execution by one or more processors. Before dispatching a task from the scheduling table to a processor for execution, the processor may be queried to determine resource availability of the processor. For example, a task may have 5 threads to be executed. After querying a processor, it may be determined that the processor has resources available to execute 3 threads. Thus, 3 of the 5 threads of the task can be dispatched to the processor for execution. After those threads complete, the processor can be queried again to determine a new resource availability of the processor. If there are sufficient resources available to execute the remaining 2 threads of the task, the 2 threads can be dispatched for execution by the processor.

In some cases, a task can depend on another task. For example, a first task (e.g., a producer task) may generate data that another task (e.g., a consumer task) uses during execution. In some cases, a task can have more than one dependent task. In some cases, a task can depend on more than one producer task. If a consumer task is provided to a processor (e.g., central processing unit (CPU), graphics processing unit (GPU), data processing unit (DPU), parallel processing unit, accelerator engine, etc.) for execution before the data of the one or more producer tasks is available, the processor may wait until the data is available, resulting in inefficient use of the processor and wasted resources.

If a consumer task is provided to a processing device for execution (e.g., by a processor or processing unit of the processing device) after the data of the one or more producer tasks is available, a latency of querying the processor before providing the consumer task can reduce a throughput of the processor.

In some cases, tasks are dispatched for execution by one or more processors based on an associated priority of the task. For example, tasks with a higher priority may be dispatched for execution (e.g., provided to a processor for execution) before tasks with a lower priority. In some cases, a first task with a priority higher than a second task will be dispatched for execution before the second task even if the second task was loaded into the scheduling table before the first task.

If a high priority task is a consumer task and is waiting for its one or more producer tasks to finish before being dispatched for execution, one or more lower priority tasks can be delayed. For example, a first task may have a high priority and may be waiting on data from a producer task. A second task may have a lower priority than the first task and may be ready for execution (e.g., may not depend on data from another task, may depend on data from another task and the data may be available already, etc.). However, the second task may not be dispatched for execution until the first task (e.g., the task with the higher priority) has been dispatched, resulting in decreased processor throughput.

In some cases, a group of tasks may have a common barrier dependency. For example, a first task and a second task may be producer tasks for the same third task (e.g., a consumer task that depends on data from the first task and on data from the second task) and may have a common barrier dependency. At the end of the first task's execution, memory used by the first task may be flushed (e.g., “memflush”). At the end of the second task's execution, memory used by the second task may be flushed. Once the third task (e.g., the consumer task) begins execution, one or more caches used during execution of the first task and one or more caches used during execution of the second task may be invalidated. Processor throughput can be reduced by performing memory flushes after each producer task and invalidating caches at the beginning of each consumer task instead of performing memory flushes once for all producer tasks in the group when all the producer tasks reach the common barrier and performing cache invalidations once for all consumer tasks before the first consumer task begins execution.

Aspects of the present disclosure address the above and other deficiencies by providing for systems and techniques that provide efficient execution of dependent tasks. More specifically, the techniques dispatch a consumer task for execution by a processor when the producer task(s) are almost finished execution, reducing the amount of time the processor is waiting for the data from the producer task(s) while simultaneously reducing the overhead associated with querying the processor and providing the consumer task to the processor for execution.

In some embodiments, the techniques may demote a priority of a task in the scheduling table if it is waiting for data from a producer task(s). For example, a first task may be loaded into the scheduling table and may have a high priority (e.g., priority 2 within a first range of priorities 0-63, where a lower number represents a higher priority). If the data the first task depends on is not ready yet, the priority of the first task can be demoted (e.g., changed from 2 within the first range of priorities to 66 within a second range of demoted priorities 64-127). After the first task's priority is demoted, a second task with a priority lower than the first tasks original task (e.g., a second task with a priority of 5) can be provided for execution by a processor, increasing a throughput of the processor. Once the one or more producer tasks finish preparing the data that the first task depends on, the priority of the first task can be restored (e.g., from 66 back to 2), and the first task can be provided for execution by a processor based on its original priority as compared to the priorities of the other tasks in the scheduling table.

In some embodiments, the techniques may perform clean-up operations for a group of producer tasks once, when all the tasks reach a barrier common to the tasks of the group, instead of performing the clean-up operations for each task at the end of each producer task and at the beginning of each consumer task. For example, a first producer task and a second producer task may have a common barrier dependency. After the first task finishes execution, no clean-up tasks may be performed. After the second task finishes execution, clean-up operations may be performed for both the first task and the second task. In some embodiments, the clean-up operations include flushing memory used during execution of the task and/or invalidating caches used during execution of the task. By performing the clean-up operations at the end of a group of producer tasks instead of at the end of each individual producer task and at the beginning of each consumer task, a throughput of the processor can be increased as fewer cycles are spent performing clean-up operations.

Advantages of the disclosed embodiments over the existing technology include but are not limited to an increased task execution throughput of a processor.

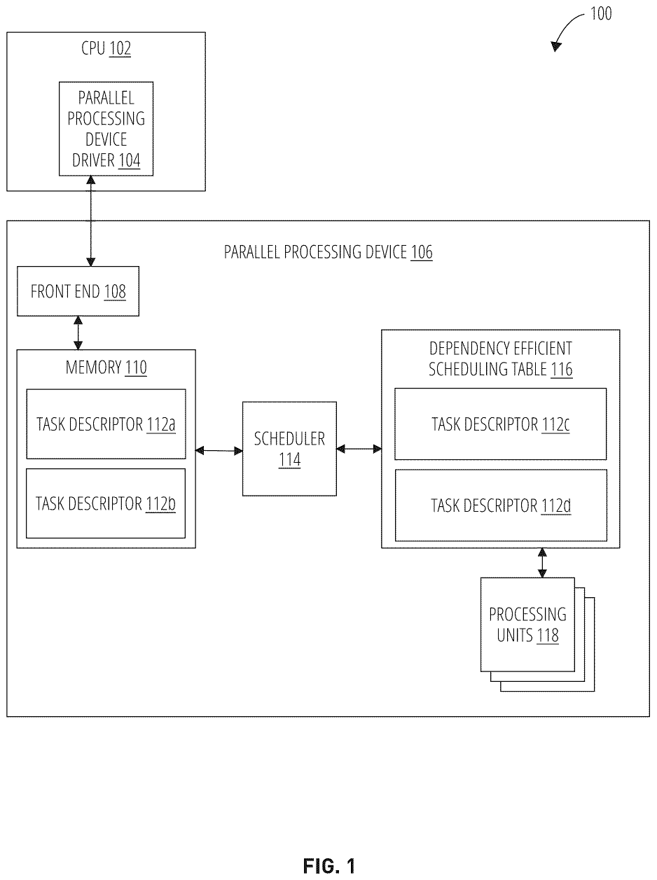

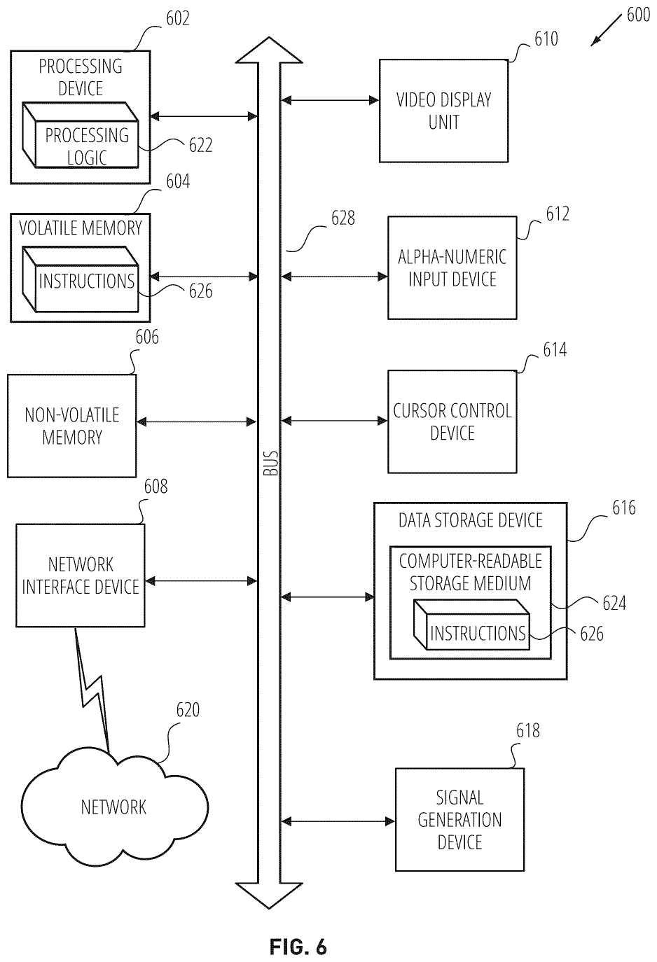

FIG. 1 is a block diagram of an example computer system 100 for efficient execution of dependent tasks, according to at least one embodiment. System 100 can include a central processing unit (CPU) 102 and a parallel processing device 106. In some embodiments, CPU 102 and parallel processing device 106 can be included within another system (e.g., computer system 600 of FIG. 6). For example, system 100 can be comprised within a desktop computer, a server, a laptop, a mobile device, and/or the like. In some embodiments, parallel processing device 106 can be used to perform machine learning and/or artificial intelligence (AI) tasks. For example, parallel processing device 106 can be used for training AI models, performing inferencing using trained AI models, and/or the like.

CPU 102 can include parallel processing device driver 104 for interfacing with parallel processing device 106. CPU 102 can send via parallel processing device driver 104 one or more task descriptors to parallel processing device 106 for execution. In some embodiments, parallel processing device driver 104 can inspect task descriptors as they are received from CPU 102.

Parallel processing device 106 can include front end 108, memory 110, scheduler 114, dependency efficient scheduling table 116, and one or more processing units 118 (e.g., parallel processing units). Front end 108 can interface with CPU 102 via parallel processing device driver 104. Front end 108 can receive one or more task descriptors from CPU 102 that are to be executed by parallel processing device 106 (e.g., by processing units 118). In some embodiments, task descriptors from CPU 102 (or parallel processing device driver 104) are stored initially in memory 110 of parallel processing device 106. Front end 108 can read the task descriptors from memory 110, make any necessary modifications to the task descriptor, and then save the modified task descriptor back to memory 110.

For example, memory 110 can include task descriptor 112a and task descriptor 112b. Task descriptor 112a can include dependency information and task state information related to the task. The dependency information can include information about synchronization points (e.g., barriers) related to the task descriptor, one or more references to task descriptors on which this task descriptor depends, and/or one or more to task descriptors that depend on this task descriptor. In some embodiments, the task state information can include a raster state of the task and a shader state of the task. The task state information can be used to track an execution progress of the task. For example execution information of the task descriptor can include whether the task descriptor is currently being executed (“in-flight”), a number of threads of the task descriptor that have been executed, a number of threads remaining to be executed, whether clean-up operations for the task descriptor have been performed, and/or the like. In some embodiments, a task descriptor is considered “in-flight” if at least one thread of the task descriptor is being executed. In some embodiments, the execution information can be used if the task needs to be interrupted or preempted during execution and later resume execution without losing its state.

In some embodiments, task descriptor 112a may include a task priority. For example, the task priority may be represented as a value within a range of values (e.g., 0-63, 0-127, etc.). In some embodiments, a low value means the task has a high priority and can be provided for execution before tasks with a lower priority (e.g., higher priority value). In some embodiments, a low value means the task has a low priority and can be provided for execution after tasks with a higher priority (e.g., higher priority value).

Similarly, task descriptor 112b can include dependency information, task state information related to the task, and a task priority value. As an example, task descriptor 112a may have a priority value of 2 and may include a reference to task descriptor 112b which may depend on data of task descriptor 112a (e.g., data created by task descriptor 112a, data modified by task descriptor 112a, etc.). Task descriptor 112b may have a priority of 0 (e.g., a highest priority) and may include a reference to task descriptor 112a on which it depends. In other words, task descriptor 112a may be a producer task and task descriptor 112b may be a consumer task that depends on task descriptor 112a.

If task descriptor 112a and task descriptor 112b were both loaded into dependency efficient scheduling table 116, even though task descriptor 112b has a higher priority than task descriptor 112a, task descriptor 112a may be provided for execution (e.g., by processing units 118) before task descriptor 112b because task descriptor 112b depends on data of task descriptor 112a.

Scheduler 114 can read task descriptors from memory 110 and load them into dependency efficient scheduling table 116. Dependency efficient scheduling table 116 can include one or more task descriptors (e.g., task descriptor 112c, task descriptor 112d, etc.), each of which may include dependency information, task state information related to the task, and/or a task priority value, as described above. Dependency efficient scheduling tables 116 can launch task descriptors for execution by one or more processing units 118. During execution of a task descriptor, the state of the task descriptor in dependency efficient scheduling table 116 can be updated. For example, during execution, execution information of the task descriptor (e.g., task descriptor 112c), raster state, shader state, and/or the like can be updated.

To achieve high processing unit occupancy (e.g., high utilization of processing units 118) and high processing unit throughput, task descriptors can be selected for execution from dependency efficient scheduling table 116 based on one or more properties of the task descriptors, such as the dependency information of the task descriptors and their priority values.

As discussed above, before dispatching a task descriptor from dependency efficient scheduling table 116 to a processor (e.g., processing units 118) for execution, the processor may be queried to determine resource availability of the processor (“state sync”). For example, a task may have 5 threads to be executed. After querying a processor, it may be determined that the processor has resources available to execute 3 threads. Thus, 3 of the 5 threads of the task can be dispatched to the processor for execution. After those threads complete, the processor can be queried again to determine a new resource availability of the processor. If there are sufficient resources available to execute the remaining 2 threads of the task, the 2 threads can be dispatched for execution by the processor.

Performing state sync can require many compute cycles and can introduce latency, reducing a throughput of a processing device (e.g., parallel processing device 106). The latency related to the state sync of a particular task descriptor can be “hidden” if the state sync is performed while one or more other task descriptors are being executed.

After selecting a task descriptor to execute and performing the state sync, one or more threads of the task descriptor can be provided to processing units 118 for execution. The state of the task descriptor can be updated in dependency efficient scheduling table 116 during execution. For example, after performing the state sync for the task descriptor, the state of the task descriptor may be updated to indicate state sync has been performed. After providing one or more threads of the task descriptor for execution, the state of the task descriptor may be updated to indicate the number of threads that have been provided for execution and/or may be updated to indicate the number of threads that still need to be provided for execution. The state of the task descriptor may be updated periodically based on execution of the threads of the task descriptor.

In some embodiments, if a task descriptor depends on data of another task descriptor and that data is not yet ready, state sync may be performed for a task descriptor without providing threads of the task descriptor to the processing units for execution. For example, dependency efficient scheduling table 116 can include task descriptor 112c and task descriptor 112d. Task descriptor 112c can be a producer task, and task descriptor 112d can be a consumer task that depends on task descriptor 112c. State sync can be performed for task descriptor 112c, and one or more threads of task descriptor 112c can be provided to processing units 118 for execution. While threads of task descriptor 112c are being executed, state sync can be performed for task descriptor 112d, thus “hiding” the latency associated with task descriptor 112d's state sync. If one or more threads of task descriptor 112c have not yet begun execution when task descriptor 112d's state sync finishes, dependency efficient scheduling table 116 may wait to provide any threads of task descriptor 112d for execution because the processing unit would need to wait idle until the data of task descriptor 112c is available, resulting in inefficient processing unit utilization. If dependency efficient scheduling table 116 includes another, independent task descriptor (e.g., a task descriptor that does not depend on the data of task descriptor 112c), such as task descriptor 112a, state sync can be performed for the independent task descriptor, and one or more threads of the independent task descriptor can be provided for execution while task descriptor 112d is waiting for all threads of task descriptor 112c to finish execution.

In some embodiments, producer task(s) can be loaded from memory (e.g., memory 110) into the scheduling table (e.g., dependency efficient scheduling table 116) and the corresponding consumer task(s) may not be in the scheduling table. Because the scheduling table may have limited space, it can be advantageous to wait to load the consumer task(s) from memory until the producer task(s) are executing. In some embodiments, the consumer task(s) may be loaded from memory into the scheduling table responsive to execution of the producer task(s) satisfying an execution criterion. For example, the consumer task(s) may be loaded from memory into the scheduling table responsive to the last thread of the producer task(s) being provided for execution (e.g., when a first execution criterion is satisfied). In some cases, the consumer task(s) may be loaded from memory into the scheduling table responsive to a “pre exit” instruction being executed during execution of a thread of the producer task(s).

In some embodiments, one or more threads of task descriptor 112d can be provided for execution before the data of task descriptor 112c is available and can reduce the amount of time the processing unit executing the one or more threads sits idle. For example, one or more threads of task descriptor 112d can be provided for execution once all threads of task descriptor 112c have finished execution (e.g., when a second execution criterion is satisfied). While the one or more threads of task descriptor 112d begin execution, one or more clean-up operations can be performed for task descriptor 112c. The clean-up operations can include flushing memory used during execution of task descriptor 112c (“memflush”) and/or invalidating caches used during execution of task descriptor 112c. In some cases, the data of task descriptor 112c that task descriptor 112d depends on may not be available until after the memflush is performed.

Processing units 118 executing the one or more threads of task descriptor 112d can execute operations that do not depend on the data of task descriptor 112c while the memflush of task descriptor 112c is being performed. For example, processing units 118 can load (e.g., fetch) instructions and/or constants that will be used during execution of task descriptor 112d. Processing units 118 may idle once they reach instructions that depend on data of task descriptor 112c. After task descriptor 112c's memflush is finished, the data task descriptor 112d is waiting for may be available, and processing units 118 can continue execution of task descriptor 112d.

By beginning execution of the consumer task (e.g., task descriptor 112d) while the producer task's (e.g., task descriptor 112c) memflush is being performed, at least part of the memflush latency can be “hidden.”

In some embodiments, dependency efficient scheduling table 116 selects task descriptors for execution based on an associated priority value of the task descriptors. For example, task descriptors with a higher priority may be provided for execution before task descriptors with a lower priority. In some cases, a first task descriptor (e.g., task descriptor 112d) with a priority higher than a second task descriptor (e.g., task descriptor 112c) will be provided for execution before the second task descriptor even if the second task descriptor was loaded into dependency efficient scheduling table 116 before the first task descriptor.

If a high priority task is a consumer task and is waiting for its one or more producer tasks to finish before being provided for execution, as described above, one or more lower priority tasks can be delayed. To avoid the delay and the associated decreased processing device throughput, dependency efficient scheduling table 116 may demote (e.g., decrease) a consumer task's priority value while its one or more producer tasks are “in-flight” to allow other task descriptors to execute before the consumer task is ready for execution. For example, a first task may be loaded into dependency efficient scheduling table 116 and may have a high priority (e.g., priority 2 within a first range of priorities 0-63, where a lower number represents a higher priority). If the data the first task depends on is not ready yet or if the producer task is still being executed, the priority of the first task can be demoted (e.g., changed from 2 within the first range of priorities to 66 within a second range of demoted priorities 64-127). After the first task's priority is demoted, a second task with a priority lower than the first tasks original task (e.g., a second task with a priority of 5) can be provided for execution by a processor, increasing a throughput of the processor. Once the one or more producer tasks finish execution or finish preparing the data that the first task depends on, the priority of the first task can be restored (e.g., from 66 back to 2), and the first task can be provided for execution by a processor based on its original priority as compared to the priorities of the other tasks in dependency efficient scheduling table 116.

In some cases, a group of tasks may have a common barrier dependency. For example, a first task and a second task may be producer tasks for the same third task (e.g., a consumer task that depends on data from the first task and on data from the second task) and may have a common barrier dependency. To avoid delays associated with performing clean-up operations at the end of each producer task, clean-up operations for a group of tasks can be performed once, when all the tasks reach a barrier common to the tasks of the group, instead of performing the clean-up operations for each task at the end of each task.

For example, a first producer task and a second producer task may have a common barrier dependency. After the first task finishes execution, no clean-up tasks may be performed. After the second task finishes execution, clean-up operations may be performed for both the first task and the second task. If the second task were to finish execution first, no clean-up operations may be performed for the second task until the first task finishes execution. In some embodiments, the clean-up operations include flushing memory used during execution of the tasks and/or invalidating caches used during execution of the tasks. By performing the clean-up operations at the end of a group of producer tasks instead of at the end of each individual producer task and at the beginning of each consumer task, a throughput of the processor can be increased as fewer cycles are spent performing clean-up operations.

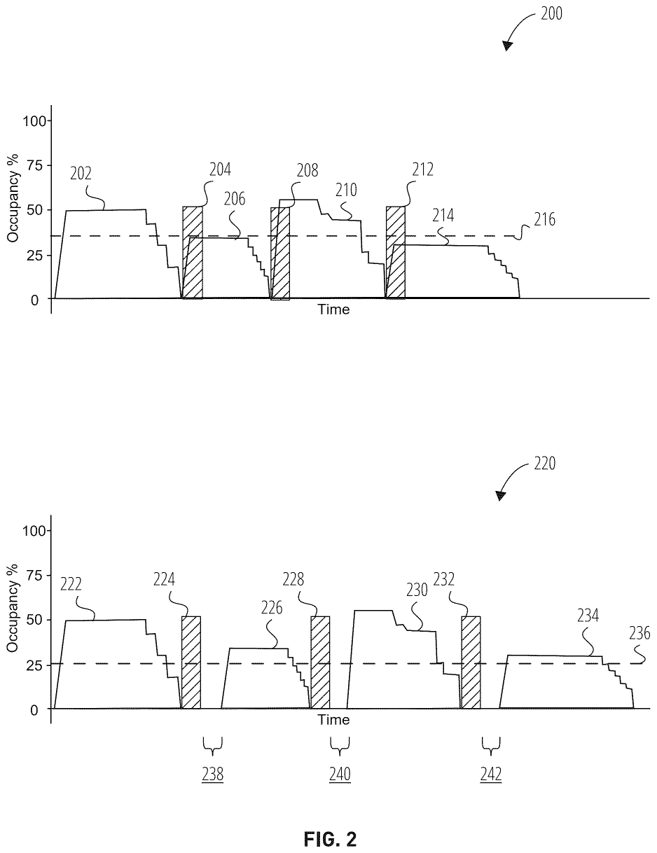

FIG. 2 is an example graph 200 of processing unit occupancy over time of a processing unit of a parallel processing device configured for efficient execution of dependent tasks, according to at least one embodiment. Graph 200 depicts a processing unit with an occupancy percentage around 37%, depicted by average occupancy line 216, and includes elements depicting execution of multiple tasks: task 0 202, task 1 206, task 2 210, and task 3 214. In the example included in FIG. 2, task 0 202 can be a producer task and can have task 1 206 as a consumer task. Task 1 206 can be a producer task and can have task 2 210 as a consumer task. Task 2 210 can be a producer task and can have task 3 214 as a consumer task.

As the threads of the task are provided to the processing unit for execution, the occupancy of the processing unit increases (as depicted by the ramp up at the left of each of task 0 202, task 1 206, task 2 210, and task 3 214). As individual threads of the task finish execution, the occupancy of the processing unit decreases (as depicted by the decreasing steps at the right of each of task 0 202, task 1 206, task 2 210, and task 3 214).

Graph 200 includes elements representing “memflush” operations as rectangles with diagonal shading: memflush 204, memflush 208, and memflush 212. As described above and as depicted in graph 200, threads of a consumer task can be provided for execution once the producer task finishes and before the memflush associated with the producer task is finished. For example, the left side of task 1 206 overlaps memflush 204, the left side of task 2 210 overlaps memflush 208, and the left side of task 3 214 overlaps memflush 212. Once the threads are provided to the processing unit, initialization operations can be performed before the memflush finishes. For example, the processing unit can load (e.g., fetch) instructions and/or constants that will be used during execution of the task. Once the initialization operations finish, the processing unit may idle until the memflush finishes. Once memflush finishes, the execution of the task can resume.

Once task 1 206 finishes execution, its corresponding memflush 208 can begin and threads of task 2 210 can be provided for execution. Once task 2 210 finishes execution, its corresponding memflush 212 can begin and threads of task 3 214 can be provided for execution.

Although it is not clearly depicted in graph 200, it should be understood that threads of a consumer task corresponding to a producer task are able to be provided immediately to the processing unit for execution once the producer task finishes execution because the consumer task descriptor has already been loaded into the scheduling table and state sync has already been performed, as discussed above. The consumer task descriptor may have been held in the scheduling table until their corresponding producer task finished execution. In some embodiments, the consumer task descriptor was loaded into the scheduling table when the last thread of the producer task began execution. In some embodiments, the priority of the consumer task descriptor was demoted while the producer task was being executed and was restored when the producer task finished execution.

FIG. 2 also includes an example graph 220 of processing unit occupancy over time of a processing unit of a parallel processing device not configured for efficient execution of dependent tasks. Graph 220 depicts a processing unit with an occupancy percentage around 26%, depicted by average occupancy line 236, and includes elements depicting execution of multiple tasks: task 0 222, task 1 226, task 2 230, and task 3 234. In the example depicted in graph 220, task 0 222 can be a producer task and can have task 1 226 as a consumer task. Task 1 226 can be a producer task and can have task 2 230 as a consumer task. Task 2 230 can be a producer task and can have task 3 234 as a consumer task.

At the threads of the task are provided to the processing unit for execution, the occupancy of the processing unit increases (as depicted by the ramp up at the left of each task 0 222, task 1 226, task 2 230, and task 3 234). As individual threads of the task finish execution, the occupancy of the processing unit decreases (as depicted by the decreasing steps at the right of each of task 0 222, task 1 226, 230, and task 3 234).

Graph 220 includes elements representing “memflush” operations as rectangles with diagonal shading: memflush 224, memflush 228, and memflush 232. As opposed to the tasks in graph 200, the tasks in graph 220 may not benefit from the advantages of the techniques disclosed herein. As depicted in graph 220, once task 0 222 finishes execution, its corresponding memflush 224 begins. At the conclusion of memflush 224, occupancy of the processing unit is at 0 for a time, represented by gap 238. During gap 238, the task descriptor of task 1 226 (e.g., the consumer task corresponding to producer task 0 222) may be loaded from memory into a scheduling table and/or state sync may be performed for the task descriptor. Once the task descriptor is loaded into the scheduling table and state sync has been performed, threads of task 1 226 can be provided to the processing unit for execution and execution can begin. This pattern repeats for the remaining tasks of graph 220.

Once task 1 226 finishes execution, its corresponding memflush 228 begins. At the conclusion of memflush 228, occupancy of the processing unit is at 0 during gap 240. The task descriptor for task 2 230 can be loaded from memory, state sync can be performed, then threads of task 2 230 can be provided for execution, and execution can begin.

Once task 2 230 finishes execution, its corresponding memflush 232 begins. At the conclusion of memflush 232, occupancy of the processing units is at 0 during 242. The task descriptor for task 3 234 can be loaded from memory, state sync can be performed, then threads of task 3 234 can be provided for execution, and execution can begin.

Due to the gaps in graph 220 and because consumer task threads are not provided when the producer task finishes execution, the average occupancy percentage of graph 220 is reduced as compared to that of graph 200.

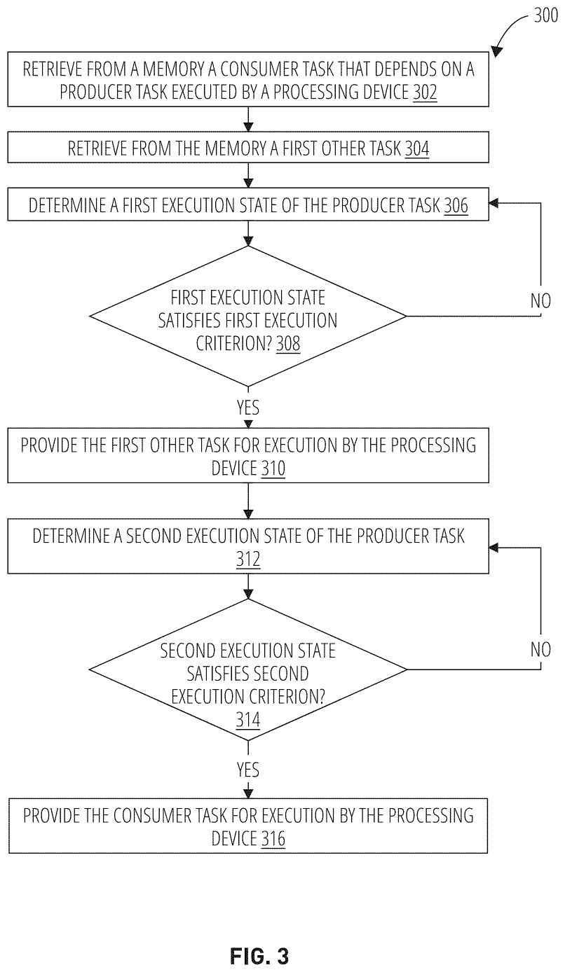

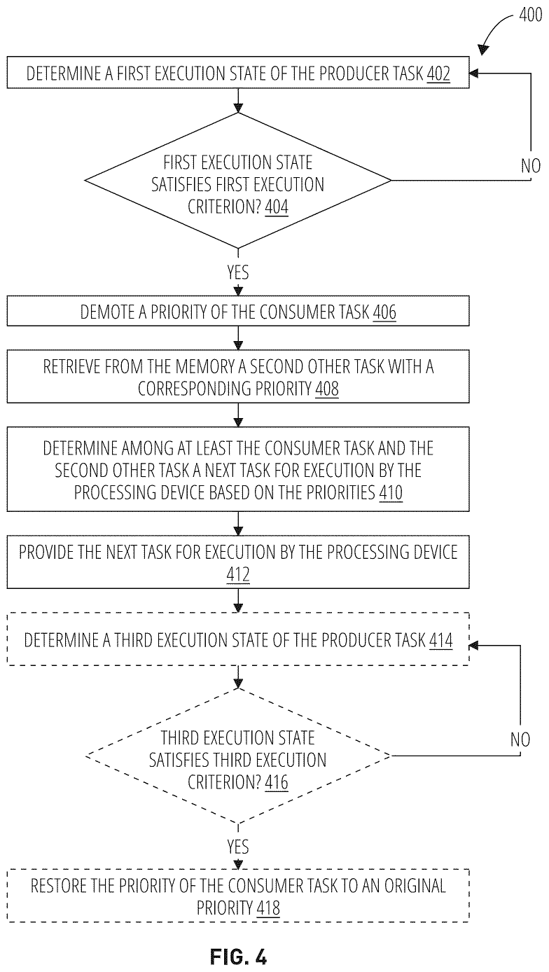

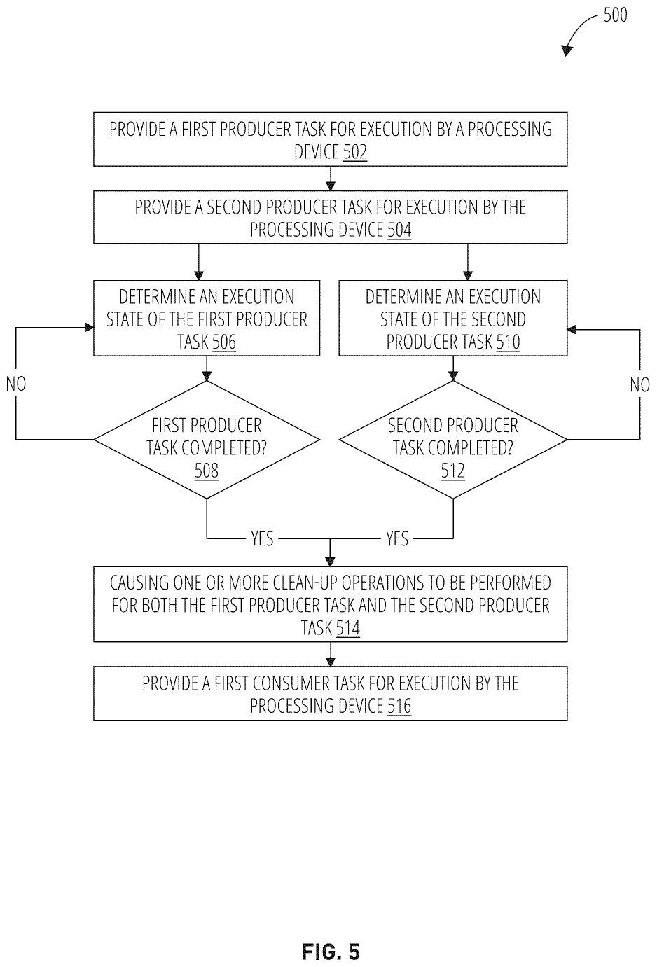

FIG. 3 is a flow diagram of an example method 300 of holding a consumer task's execution for efficient execution of dependent tasks, according to at least one embodiment. FIG. 4 is a flow diagram of an example method 400 of demoting a consumer task's priority for efficient execution of dependent tasks, according to at least one embodiment. FIG. 5 is a flow diagram of an example method 500 for efficient clean-up operations of producer tasks, according to at least one embodiment.

Methods 300, 400, and/or 500 can be performed using one or more processing units (e.g., CPUs, GPUs, accelerators, physics processing units (PPUs), data processing units (DPUs), parallel processing units, etc.), which may include (or communicate with) one or more memory devices. In at least one embodiment, methods 300, 400, and/or 500 can be performed using a processing device or processing devices. In at least one embodiment, methods 300, 400, and/or 500 can be performed using processing circuitry. In at least one embodiment, methods 300, 400, and/or 500 can be performed using circuitry of parallel processing device 106 of FIG. 1. In at least one embodiment, methods 300, 400, and/or 500 can be performed using dependency efficient scheduling table 116 of parallel processing device 106 of FIG. 1.

In at least one embodiment, processing units performing any of methods 300, 400, and/or 500 can be executing instructions stored on a non-transient computer readable storage media. In at least one embodiment, any of methods 300, 400, and/or 500 can be performed using multiple processing threads (e.g., CPU threads and/or GPU threads), individual threads executing one or more individual functions, routines, subroutines, or operations of the method. In at least one embodiment, processing threads implementing any of methods 300, 400, and/or 500 can be synchronized (e.g., using semaphores, critical sections, and/or other thread synchronization mechanisms). Alternatively, processing threads implementing any of methods 300, 400, and/or 500 can be executed asynchronously with respect to each other. Various operations of methods 300, 400, and/or 500 can be performed in a different order compared with the order shown in FIG. 3, FIG. 4, and FIG. 5. Some operations of any of methods 300, 400, and/or 500 can be performed concurrently with other operations. In at least one embodiment, one or more operations shown in FIG. 3, FIG. 4, and/or FIG. 5 may not always be performed.

Referring to FIG. 3, at block 302, processing units executing method 300 can retrieve from a memory a consumer task that depends on a producer task executed by a processing device (e.g., executed by a processor or processing unit of a processing device). In some embodiments, the consumer task further depends on another producer task. In some embodiments, the producer task produces data to be consumed by more than one consumer task.

At block 304, processing units can retrieve from the memory a first other task. At block 306, processing units can determine a first execution state of the producer task. For example, processing units may query a processor for a current execution state of the producer task. In some cases, processing units may receive from the processor a report (e.g., one or more signals or values) including an execution state of the producer task.

At decision block 308, if the first execution state indicates that not all threads of the producer task have begun execution, processing units may return to block 306 and again determine the first execution state of the producer task.

If the first execution state indicates that all threads of the producer task have begun execution, at block 310, processing units may provide the first other task for execution by the processing device. As discussed above, if one or more threads of the producer task still need to begin execution, the consumer task may be held in the scheduling table and may not be provided to a processor for execution. Another task that is ready for execution (e.g., a task with no dependencies or a task whose producer task(s) have already finished) can be provided for execution before the consumer task.

At block 312, processing units can determine a second execution state of the producer task. At decision block 314, if the second execution state does not satisfy a second execution criterion, processing units may return to block 312 and again determine the second execution state of the producer task.

If the second execution state satisfies the second execution criterion, at block 316, processing units may provide the consumer task for execution by the processing device. In some embodiments, the second execution criterion is based on the threads of the producer task finishing execution. For example, if all threads of the producer task have finished execution, the second execution criterion may be satisfied.

In some embodiments, providing the consumer task for execution by the processing device is further responsive to a resource availability of the processing device satisfying a resource criterion. For example, a state of the processing device may be queried to determine the available resources of the processing device. The consumer task can include one or more resource requirements. If the available resources of the processing device satisfy the one or more resource requirements of the consumer task, the consumer task (or one or more threads of the consumer task) can be provided to the processing device for execution.

In some embodiments, processing units may retrieve from the memory the consumer task that depends on the producer task executed by the processing device responsive to the first execution state of the producer task satisfying the first execution criterion. In some embodiments, the first execution criterion is based on the last thread of the producer task being provided for execution. For example, if the last thread of the producer task has begun execution, the first execution criterion may be satisfied. In some embodiments, the first execution criterion is based on execution of a “pre exit” instruction during execution of the producer task.

Referring now to FIG. 4, in some embodiments, method 400 is performed after (or in conjunction with) method 300. At block 402, processing units performing method 400 may determine a first execution state of the producer task. At decision block 404, if the first execution state indicates that not all threads of the producer task have begun execution, processing units may return to block 402 and again determine the first execution state of the producer task. In some embodiments, block 402 and decision block 404 correspond to block 306 and decision block 308 of FIG. 3.

If the first execution state indicates that all threads of the producer task have begun execution, at block 406, processing units may demote a priority of the consumer task. At block 408, processing units may retrieve from the memory a second other task with a corresponding priority. At block 410, processing units may determine among at least the consumer task and the second other task a next task for execution by the processing device based on the priorities (e.g., the priority of the consumer task and the priority of the second other task). At block 412, processing units may provide the next task for execution by the processing device.

In some embodiments, at block 414, processing units may determine a third execution state of the producer task. At decision block 416, if the third execution state does not satisfy a third execution criterion, processing units may return to block 414 and again determine the third execution state of the producer task. In some embodiments, the third execution state indicates whether memory of the producer task has been flushed yet (e.g., whether “memflush” has been performed for the producer task). For example, if the third execution state indicates that memflush has been performed for the producer task, the third execution criterion may be satisfied.

If the third execution state does satisfy the third execution criterion, at block 418, processing units may restore the priority of the consumer task to an original priority.

Referring now to FIG. 5, at block 502, processing units may provide a first producer task for execution by a processing device. At block 504, processing units may provide a second producer task for execution by a processing device. In some embodiments, the first producer task and the second producer task have a common barrier dependency.

At block 506, processing units may determine an execution state of the first producer task. If the execution state of the first producer task indicates that the first producer task has not yet completed execution, processing units may return to block 506 and again determine an execution state of the first producer task.

At block 510, processing units may determine an execution state of the second producer task. If the execution state of the second producer task indicates that the second producer task has not yet completed execution, processing units may return to block 510 and again determine an execution state of the second producer task.

Once both the first producer task and the second producer task have finished execution, at block 514, processing units may cause one or more clean-up operations to be performed for both the first producer task and the second producer task. At block 516, processing units may provide a first consumer task for execution by the processing device. In some embodiments, the consumer task depends on the first producer task and the second producer task.

In some embodiments, the one or more clean-up operations include at least one of flushing a first memory related to the first producer task and a second memory related to the second producer task or invalidating first caches related to the first producer task and second caches related to the second producer task.

In some embodiments, causing the one or more clean-up operations to be performed includes providing a completion tracker task for execution by the processing device. The completion tracker task may depend on the first producer task and on the second producer task. The consumer task may depend on the completion tracker task. In some embodiments, the completion tracker task acts as a link between the producer tasks (e.g., the first producer task and the second producer task) and the consumer task. When the completion tracker task is executed, it may immediately finish execution, and a consumer task may be provided for execution.

In some embodiments, a completion tracker task descriptor is added to the scheduling table when a producer task is loaded from memory and the consumer task corresponding to the producer task is not in the scheduling table. For example, a first producer task may be loaded from memory into the scheduling table. The first producer task may generate data that is consumed by a first consumer task. If the first consumer task is not yet in the scheduling table, a completion tracker task descriptor may be added to the scheduling table and the dependency information of the producer task descriptor may be updated to point to the completion tracker task descriptor instead of the first consumer task descriptor. Once the first consumer task descriptor is loaded from memory into the scheduling table, the dependency information of the completion tracker task descriptor may be updated to point to the first consumer task descriptor. The dependency information of the first consumer task descriptor may be updated to point to the completion tracker task descriptor instead of the first producer task descriptor.

Once the first producer task finishes execution, the completion tracker task may be ready for execution since the task on which it depends has finished execution. The completion tracker task may be provided for execution and may finish execution immediately. At that point, the first consumer task may be ready for execution since the task on which it depends (the completion tracker task) has finished execution.

In some embodiments, responsive to completion of the one or more clean-up operations, processing units may provide a second consumer task for execution by the processing device. The second consumer task may depend on the first producer task and on the second producer task.

In some embodiments, the consumer task generates data that is consumed by another task. In other words, the consumer task may be a producer task for another consumer task.

FIG. 6 is a block diagram illustrating an exemplary computer system, in accordance with at least one embodiment of the present disclosure. In some embodiments, the computer system 600 can comprise system 100 of FIG. 1. Computer system 600 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 616, which communicate with each other via a bus 628.

Processor (processing device) 602 represents one or more general-purpose processing devices such as a microprocessor, central processing unit, or the like, and may include processing logic 622. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute instructions 626 (e.g., for generating threat indicator alerts) for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 618 (e.g., a speaker). In some embodiments, computer system 600 may not include video display unit 610, input device 612, and/or cursor control device 614 (e.g., in a headless configuration).

The data storage device 616 can include a non-transitory machine-readable storage medium 624 (also computer-readable storage medium) on which is stored one or more sets of instructions 626 (e.g., for efficient execution of dependent tasks) embodying any one or more of the methodologies or functions described herein. The instructions 626 can also reside, completely or at least partially, within the main memory 604 and/or within the processor 602 during execution thereof by the computer system 600, the main memory 604 and the processor 602 also constituting machine-readable storage media. The instructions can further be transmitted or received over a network 620 via the network interface device 608.

In one implementation, the instructions 626 include instructions for efficient execution of dependent tasks. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

### Inference and Training Logic

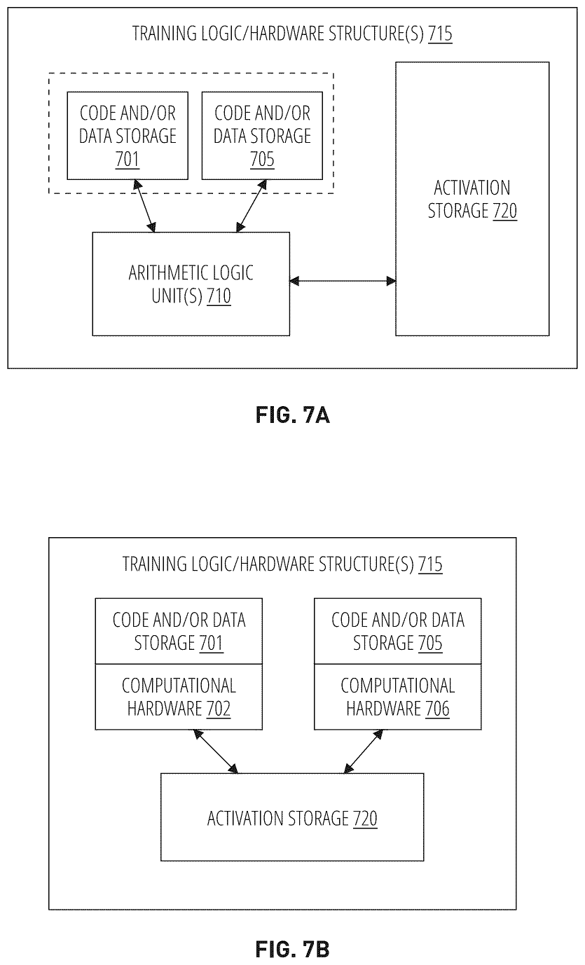

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include (or be coupled to code and/or data storage 701 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include (or be coupled to code and/or data storage 705 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, the result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

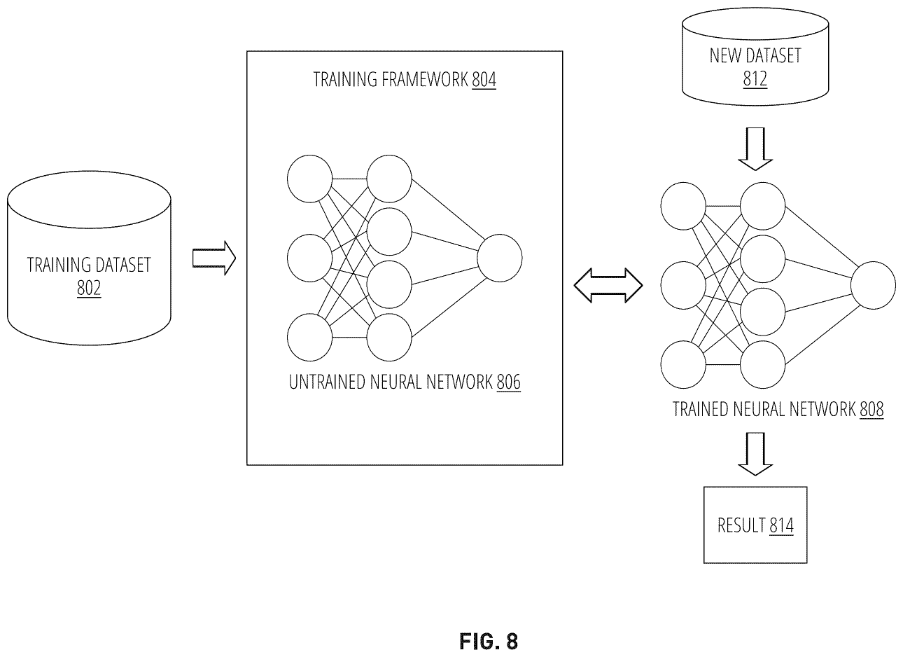

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

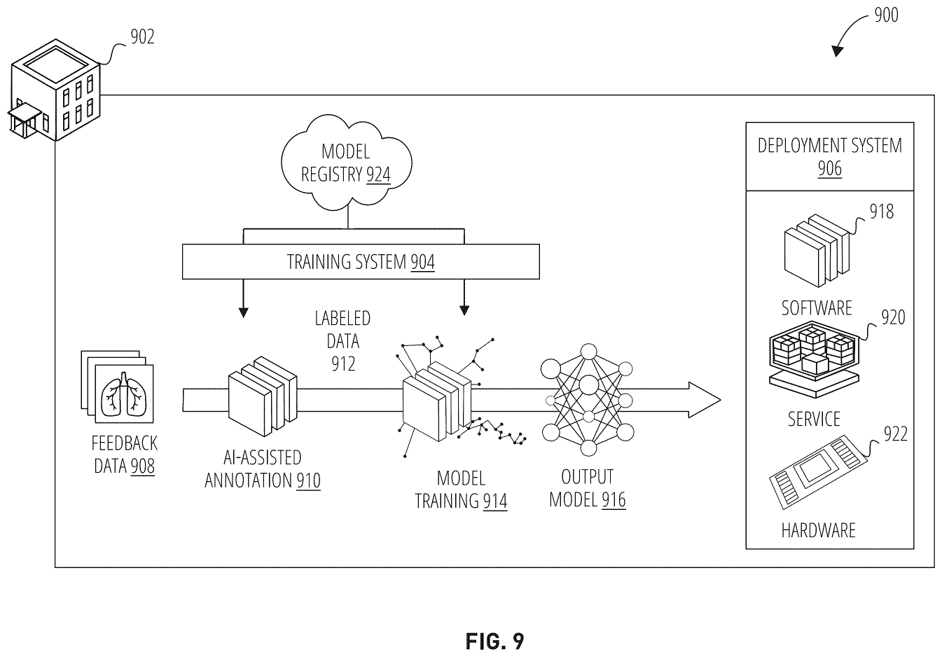

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

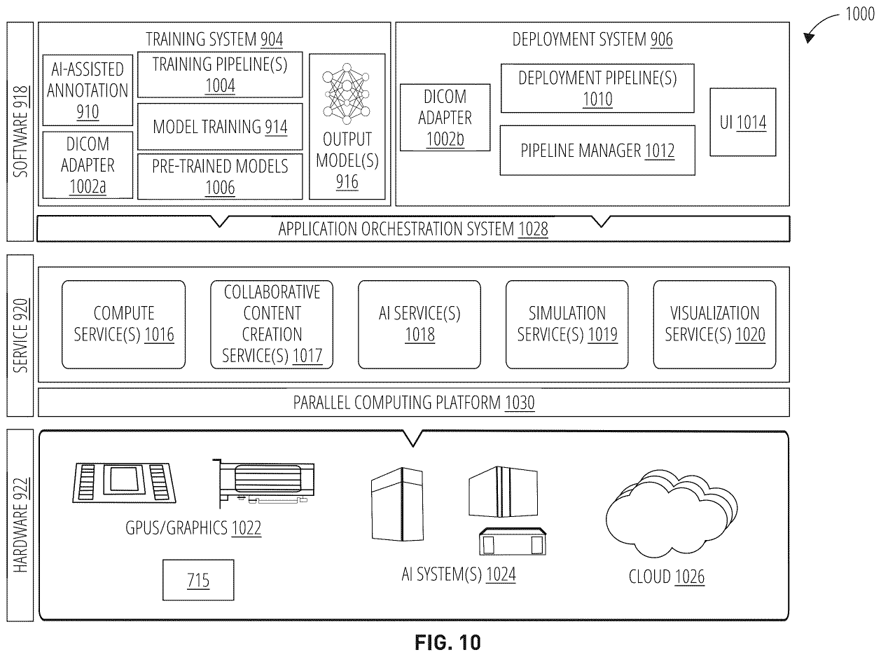

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 1004 (FIG. 10) may include a scenario where facility 902 is training their own machine learning model or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIG. 9 and/or FIG. 10. In at least one embodiment, a trained machine learning model may be referred to as an output model 916, and may be used by deployment system 906, as described herein.

In at least one embodiment, training pipeline(s) 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained - or partially trained - at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model(s) 916—and may be used in deployment system 906 to perform one or more processing tasks for one or more applications of a deployment system.

In at least one embodiment, training pipeline(s) 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914 may include data—e.g., AI-assisted annotations 910, labeled data 912, or a combination thereof—that may be used as ground truth data for retraining or updating a machine learning model.

In at least one embodiment, deployment system 906 may include software 918, service 920, hardware 922, and/or other components, features, and functionality. In at least one embodiment, deployment system 906 may include a software “stack,” such that software 918 may be built on top of service 920 and may use service 920 to perform some or all of processing tasks, and service 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage service 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 920 may be leveraged. In at least one embodiment, service 920 may include compute services, collaborative content creation services, simulation services, artificial intelligence (AI) services, visualization services, and/or other service types. In at least one embodiment, service 920 may provide functionality that is common to one or more applications in software 918, so functionality may be abstracted to a service that may be called upon or leveraged by applications. In at least one embodiment, functionality provided by service 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and service 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or service 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipeline(s) 1010 by deployment system 906, training pipeline(s) 1004 may be used to train or retrain one or more (e.g., pre-trained) models, and/or implement one or more of pre-trained models 1006 (e.g., without a need for retraining or updating). In at least one embodiment, as a result of training pipeline(s) 1004, output model(s) 916 may be generated. In at least one embodiment, training pipeline(s) 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, DICOM adapter 1002a can be used to access DICOM data. In at least one embodiment, for different machine learning models used by deployment system 906, different training pipeline(s) 1004 may be used. In at least one embodiment, training pipeline(s) 1004, similar to a first example described with respect to FIG. 9, may be used for a first machine learning model, training pipeline(s) 1004, similar to a second example described with respect to FIG. 9, may be used for a second machine learning model, and training pipeline(s) 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904 and may be implemented by deployment system 906.

In at least one embodiment, output model(s) 916 and/or pre-trained models 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipeline(s) 1010; either in addition to, or in lieu of, AI-assisted annotation included in training pipeline(s) 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipeline(s) 1010 may include any number of applications that may be sequentially, non-sequentially, or otherwise applied to feedback data (and/or other data types), including AI-assisted annotation, as described above. In at least one embodiment, as described herein, a deployment pipeline(s) 1010 for an individual device may be referred to as a virtual instrument for a device. In at least one embodiment, for a single device, there may be more than one deployment pipeline(s) 1010 depending on information desired from data generated by a device.

In at least one embodiment, applications available for deployment pipeline(s) 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of the applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute service(s) 1016, collaborative content creation service(s) 1017, AI service(s) 1018, simulation service(s) 1019, visualization service(s) 1020, and/or other service types. In at least one embodiment, applications may call (e.g., execute) one or more of services 920 to perform processing operations for an application. In at least one embodiment, compute service(s) 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs/graphics 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1018 may be leveraged to perform inferencing services for executing machine learning model(s) associated with applications (e.g., tasked with performing one or more processing tasks of an application). In at least one embodiment, AI service(s) 1018 may leverage AI system(s) 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output model(s) 916 from training system 904 and/or other models of applications to perform inference on imaging data (e.g., DICOM data, RIS data, CIS data, REST compliant data, RPC data, raw data, etc.). For example, DICOM adapter 1002b may be used to access DICOM data. In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI service(s) 1018.

In at least one embodiment, shared storage may be mounted to AI service(s) 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization service(s) 1020 may be leveraged to generate visualizations for viewing outputs of applications and/or deployment pipeline(s) 1010. In at least one embodiment, GPUs/graphics 1022 may be leveraged by visualization service(s) 1020 to generate visualizations. In at least one embodiment, rendering effects, such as ray-tracing or other light transport simulation techniques, may be implemented by visualization service(s) 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1020 may include an internal visualizer, cinematics, and/or other rendering or image processing capabilities or functionality (e.g., ray tracing, rasterization, internal optics, etc.).

In at least one embodiment, hardware 922 may include GPUs/graphics 1022, AI system(s) 1024, cloud 1026, and/or any other hardware used for executing training system 904 and/or deployment system 906. In at least one embodiment, GPUs/graphics 1022 (e.g., NVIDIA's TESLA® and/or QUADRO® GPUs) may include any number of GPUs that may be used for executing processing tasks of compute service(s) 1016, collaborative content creation service(s) 1017, AI service(s) 1018, simulation service(s) 1019, visualization service(s) 1020, other services, and/or any of features or functionality of software 918. For example, with respect to AI service(s) 1018, GPUs/graphics 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system(s) 1024, and/or other components of system 1000 may use GPUs/graphics 1022. In at least one embodiment, cloud 1026 may include a GPU-optimized platform for deep learning tasks. In at least one embodiment, AI system(s) 1024 may use GPUs, and cloud 1026—or at least a portion tasked with deep learning or inferencing—may be executed using one or more AI system(s)s 1024. As such, although hardware 922 is illustrated as discrete components, this is not intended to be limiting, and any components of hardware 922 may be combined with, or leveraged by, any other components of hardware 922.

In at least one embodiment, AI system(s) 1024 may include a purpose-built computing system (e.g., a super-computer or an HPC) configured for inferencing, deep learning, machine learning, and/or other artificial intelligence tasks. In at least one embodiment, AI system(s) 1024 (e.g., NVIDIA's DGX™) may include GPU-optimized software (e.g., a software stack) that may be executed using a plurality of GPUs/graphics 1022, in addition to CPUs, RAM, storage, and/or other components, features, or functionality. In at least one embodiment, one or more AI system(s)s 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute service(s) 1016, AI service(s) 1018, and/or visualization service(s) 1020, as described herein. In at least one embodiment, cloud 1026 may perform small and large batch inference (e.g., executing NVIDIA's TensorRT™), provide an accelerated parallel computing platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000. In at least one embodiment, parallel computing platform 1030 may include an API.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors —for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
retrieving from a memory a consumer task that depends on a producer task executed by a processing device;
retrieving from the memory a first other task;
responsive to a first execution state of the producer task at a first time satisfying a first execution criterion, providing the first other task for execution by the processing device; and
responsive to a second execution state of the producer task at a second time satisfying a second execution criterion, providing the consumer task for execution by the processing device.

2. The method of claim 1, wherein the retrieving from the memory the consumer task that depends on the producer task executed by the processing device is responsive to the first execution state of the producer task at the first time satisfying the first execution criterion.

3. The method of claim 1, further comprising:
responsive to the first execution state of the producer task at the first time satisfying the first execution criterion, demoting a priority of the consumer task;
retrieving from the memory a second other task with a corresponding priority;
determining among at least the consumer task and the second other task a next task for execution by the processing device based on the priorities; and
providing the next task for execution by the processing device.

4. The method of claim 3, further comprising:
responsive to a third execution state of the producer task at a third time satisfying a third execution criterion, restoring the priority of the consumer task to an original priority.

5. The method of claim 1, wherein the producer task produces data to be consumed by more than one consumer task.

6. The method of claim 1, wherein the consumer task further depends on another producer task.

7. The method of claim 1, wherein the providing the consumer task for execution by the processing device is further responsive to a resource availability of the processing device satisfying a resource criterion.

8. A circuit coupled to a parallel processing unit and a memory, the circuit to:
retrieve from the memory a consumer task that depends on a producer task executed by the parallel processing unit;
retrieve from the memory a first other task;
responsive to a first execution state of the producer task at a first time satisfying a first execution criterion, provide the first other task for execution by the parallel processing unit; and
responsive to a second execution state of the producer task at a second time satisfying a second execution criterion, provide the consumer task for execution by the parallel processing unit.

9. The circuit of claim 8, wherein retrieving from the memory the consumer task that depends on the producer task executed by the parallel processing unit is performed responsive to the first execution state of the producer task at the first time satisfying the first execution criterion.

10. The circuit of claim 8, the circuit further to:
responsive to the first execution state of the producer task at the first time satisfying the first execution criterion, demote a priority of the consumer task;
retrieve from the memory a second other task with a corresponding priority;
determine among at least the consumer task and the second other task a next task for execution by the parallel processing unit based on the priorities; and
provide the next task for execution by the parallel processing unit.

11. The circuit of claim 10, the circuit further to:
responsive to a third execution state of the producer task at a third time satisfying a third execution criterion, restore the priority of the consumer task to an original priority.

12. The circuit of claim 8, wherein the producer task produces data to be consumed by more than one consumer task.

13. The circuit of claim 8, wherein the consumer task further depends on another producer task.

14. The circuit of claim 8, wherein providing the consumer task for execution by the parallel processing unit is further responsive to a resource availability of the parallel processing unit satisfying a resource criterion.

15. A method comprising:
providing a first producer task for execution by a processing device;
providing a second producer task for execution by the processing device;
responsive to completion of the first producer task and the second producer task, causing one or more clean-up operations to be performed for both the first producer task and the second producer task; and
responsive to completion of the one or more clean-up operations, providing a first consumer task for execution by the processing device, wherein the first consumer task depends on the first producer task and on the second producer task.

16. The method of claim 15, wherein the one or more clean-up operations for both the first producer task and the second producer task comprise at least one of:
flushing a first memory related to the first producer task and a second memory related to the second producer task; or
invalidating first caches related to the first producer task and second caches related to the second producer task.

17. The method of claim 15, wherein the causing the one or more clean-up operations to be performed comprises providing a completion tracker task for execution by the processing device, wherein the completion tracker task depends on the first producer task and on the second producer task.

18. The method of claim 15, wherein the first producer task and the second producer task have a common barrier dependency.

19. The method of claim 15, further comprising:
responsive to completion of the one or more clean-up operations, providing a second consumer task for execution by the processing device, wherein the second consumer task depends on the first producer task and on the second producer task.

20. The method of claim 15, wherein the first consumer task generates data that is consumed by another task.
